(19) United States
(12) Patent Application Publication
(10) Pub. No.: US 2008/0316377 A1
(43) Pub. Date: Dec. 25, 2008

(54) LIQUID CRYSTAL PROJECTION APPARATUS

(75) Inventors: Chui-Ping Chen, Hsinchu (TW); Nien-Hui Hsu, Hsinchu (TW); Sze-Ke Wang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsinchu (TW)

(21) Appl. No.: 11/960,732

(22) Filed: Dec. 20, 2007

(30) Foreign Application Priority Data
Jun. 22, 2007 (TW) 96122440

(51) Int. Cl. G02F 1/13

(52) U.S. Cl. 349/9

(57) ABSTRACT

A liquid crystal projection apparatus includes an illumination system, at least a light-transforming module and a projection lens. The illumination system provides a light beam having light polarized in a first direction and in a second direction. The light-transforming module and the projection lens are both disposed on a transmission path of the light beam. The light-transforming module includes a transmissive liquid crystal display (LCD) panel, a plurality of first polarizers and at least a second polarizer. The light polarized in a first direction passes through the first polarizers disposed at a side of the transmissive LCD panel, and the light polarized in a second direction is partially blocked by each of the first polarizers. The light polarized in the second direction passes through the second polarizer disposed at another side of the transmissive LCD panel, and the light polarized in the first direction is blocked by the second polarizer.

### CROSS-REFERENCE TO RELATED APPLICATION

This application claims the priority benefit of Taiwan application serial no. 96122440, filed on Jun. 22, 2007. The entirety of the above-mentioned patent application is hereby incorporated by reference herein and made a part of this specification.

### BACKGROUND OF THE INVENTION

1. Field of the Invention

The present invention relates to a liquid crystal projection apparatus. More particularly, the present invention relates to a transmissive liquid crystal projection apparatus.

2. Description of Related Art

Referring to FIG. 1, a conventional single panel transmissive liquid crystal projection apparatus 100 includes a light source 110, a color wheel 120, a light integration rod 130, a focusing lens 140, a P-polarizer 150p, an S-polarizer 150s, a transmissive liquid crystal display (LCD) panel 160 and a projection lens 170. The light source 110 provides a white light beam 112. The color wheel 120, the light integration rod 130, the focusing lens 140, the P-polarizer 150p, the transmissive LCD panel 160, the S-polarizer 150s and the projection lens 170 are sequentially disposed on a transmission path of the light beam 112. A P-polarized light in the light beam 112 passes through the P-polarizer 150p. The P-polarized light is suitable for being converted into a S-polarized light by the transmissive LCD panel 160, and the S-polarized light passes through the S-polarizer 150s.

It should be noted that since only the P-polarized light in the light beam 112 passes through the P-polarizer 150p, light energy of the light polarized in other directions will be accumulated at the P-polarizer 150p, and the P-polarizer 150p may be deteriorated due to high temperature. Therefore, image quality of the transmissive LCD projector 100 will be decreased.

Referring to FIG. 2, a conventional three-panel transmissive LCD projector 200 includes a light source 210, a light integration rod 220, a focusing lens 230, a first dichroic mirror 240a, a second dichroic mirror 240b, three reflective mirrors 250a, 250b, 250c, three P-polarizers 260p, three S-polarizers 260s, three transmissive LCD panels 270, an X-prism 280 and a projection lens 290. The light source 210 provides a white light beam 212 composed of red light 212r, green light 212g and blue light 212b. The light integration rod 220, the focusing lens 230 and the first dichroic mirror 240a are sequentially disposed on the transmission path of the light beam 212.

The red light 212r passes through the first dichroic mirror 240a, and the green light 212g and the blue light 212b are reflected by the first dichroic mirror 240a. The blue light 212b passes through the second dichroic mirror 240b, and the green light 212g is reflected by the second dichroic mirror 240b. The reflective mirror 250a is disposed on a transmission path of the red light 212r, and the red light 212r is reflected by the reflective mirror 250a. The reflective mirrors 250b and 250c are disposed on the transmission path of the blue light 212b, and the blue light 212b are reflected by the reflective mirrors 250b and 250c. The red light 212r, the green light 212g and the blue light 212b are reflected on the X-prism 280 and combined to form a combination beam 282 by the X-prism 280, after respectively pass through the corresponding P-polarizer 260p, the transmissive LCD panels 270 and the S-polarizer 260s. The projection lens 290 is disposed on a transmission path of the combination beam 282.

Similar to the transmissive LCD projector 100, since the light polarized in the directions other than the P-polarized direction will be accumulated at the P-polarizers 260p, the P-polarizers 260p may be deteriorated due to high temperature. Therefore, the image quality of the transmissive LCD projector 200 will be decreased.

### SUMMARY OF THE INVENTION

The present invention is directed to a liquid crystal projection apparatus, in which light energy of a light polarized in a different direction with that of a polarizer may be uniformly distributed on a plurality of polarizers, such that the heat accumulated on the polarizers may be easily dissipated, and the service life of the polarizers may be prolonged.

Additional advantages of the present invention will be set forth in the technical features disclosed by the present invention.

According to an embodiment of the present invention, a liquid crystal projection apparatus including an illumination system, at least a light-transforming module and a projection lens is provided. The illumination system is capable of providing a light beam having light polarized in a first direction and light polarized in a second direction. The light-transforming module and the projection lens are both disposed on a transmission path of the light beam, and the projection lens is located behind the light-transforming module. The light-transforming module includes a transmissive liquid crystal display (LCD) panel, a plurality of first polarizers and at least a second polarizer. The first polarizers disposed at a side of the transmissive LCD panel. The light polarized in the first direction passes through the first polarizers, a part of the light polarized in the second direction is blocked by one of the first polarizers, and a remaining part of the light polarized in the second direction is blocked by other first polarizers. The second polarizers disposed at another side of the transmissive LCD panel. The light polarized in the second direction passes through the second polarizer, and the light polarized in the first direction is blocked by the second polarizer.

Since the light-transforming module comprises a plurality of the first polarizers, light energy of the light polarized in the directions other than the first polarized direction may be distributed on a plurality of the first polarizers, such that heat accumulated on the first polarizers may be dissipated more easily and deterioration due to high temperature is mitigated. Accordingly, the service life of the first polarizers is prolonged, and a stable image quality of the transmissive LCD projector is maintained.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a structural diagram of a conventional single panel transmissive liquid crystal projection apparatus.

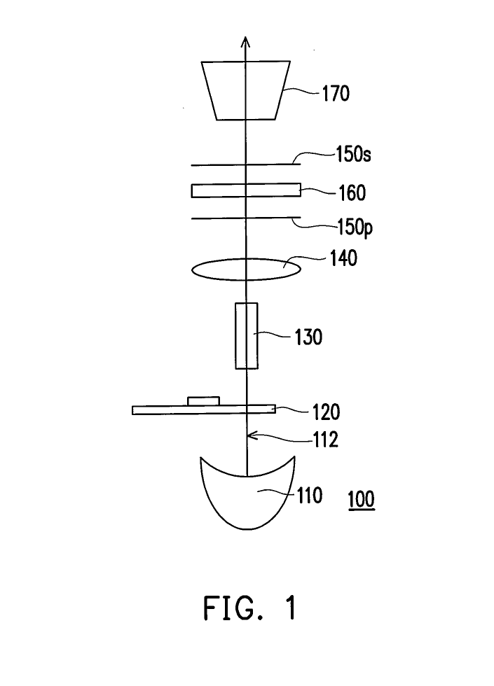

FIG. 2 is a structural diagram of a conventional three-panel transmissive liquid crystal projection apparatus.

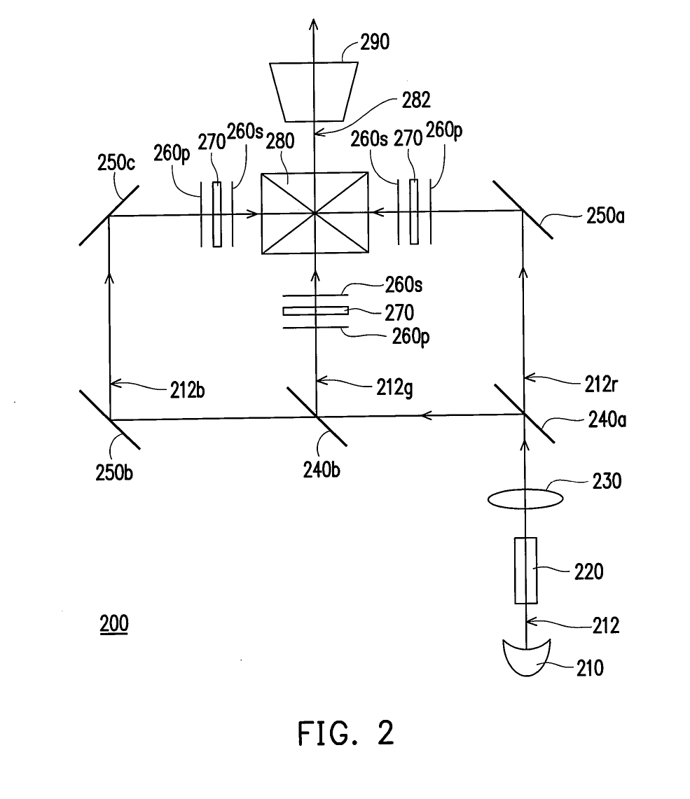

FIG. 3 is a structural diagram of a liquid crystal projection apparatus according to a first embodiment of the present invention.

FIG. 4 is a structural diagram of a liquid crystal projection apparatus according to a second embodiment of the present invention.

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

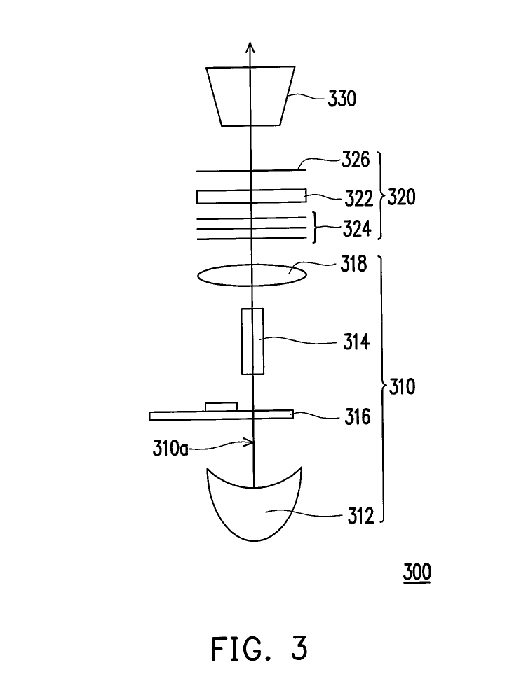

Referring to FIG. 3, a liquid crystal projection apparatus 300 in a first embodiment of the present invention includes an illumination system 310, at least a light-transforming module 320 and a projection lens 330. The illumination system 310 is capable of providing a light beam 310a polarized in a first direction and a second direction. The light-transforming module 320 and the projection lens 330 are both disposed on a transmission path of the light beam 310a, and the projection lens 330 is located behind the light-transforming module 320. The light beam 310a is capable of being converted from an illumination beam into an image beam by the light-transforming module 320. The light-transforming module 320 includes a transmissive liquid crystal display (LCD) panel 322, a plurality of first polarizers 324 and at least a second polarizer 326. The first polarizers 324 are disposed at one side of the transmissive LCD panel 322, and the second polarizer 326 is disposed at another side of the transmissive LCD panel 322.

The light polarized in the first direction in the light beam 310a passes through the first polarizers 324, a part of the light polarized in the second direction in the light beam 310a is blocked by one of the first polarizers 324, and a remaining part of the light polarized in the second direction in the light beam 310a is blocked by the other first polarizers 324. Moreover, the light polarized in the second direction in the light beam 310a passes through the second polarizer 326, and the light polarized in the first direction in the light beam 310a is blocked by the second polarizer 326. In addition, the incident light polarized in the first (second) direction is capable of being converted into the light polarized in the second (first) direction by the transmissive LCD panel 322. Furthermore, the light beam 310a (image beam) is capable of being projected onto a screen (not shown) to form an image (not shown) via the projection lens 330.

In this embodiment, the illumination system 310 may include a light source 312 and a light uniformized element 314. The light source 312 provides the light beam 310a. The light uniformized element 314 is disposed on the transmission path of the light beam 310a, and the light beam 310a is capable of being uniformized by the light uniformized element 314. The light source 312 may be an ultrahigh pressure mercury lamp (UHP lamp), a metal halide lamp, a xenon lamp or other light sources. Moreover, the light beam 310a provided by the light source 312 may be a focused beam, and the light uniformized element 314 may be a light integration rod, wherein the light integration rod may be a solid rod or a hollow rod. In addition, a length of the light integration rod may be greater than 30 millimetres, such that the reflection times of the light beam 310a in the light integration rod is increased, and distribution of the light energy is more uniformed.

In addition, the light beam 310a provided by the light source 312 may be a white light beam, and the illumination system 310 may further include a color wheel 316. The color wheel 316 is disposed on the transmission path of the light beam 310a, and is located between the light source 312 and the light uniformized element 314. The light beam 310a is converted into light with different colors (such as red, green and blue) after passes through the color wheel 316 at different time points, so as to form illumination beams with different colors. Moreover, the illumination system 310 may further include a focusing lens 318, by which the uniformed light beam 310a may be focused on the transmissive LCD panel 322. The focusing lens 318 is disposed between the light uniformized element 314 and the transmissive LCD panel 322.

Furthermore, the first polarizer 324 may be a P-polarizer, and the second polarizer 326 may be a S-polarizer; the first polarized direction may be a P-polarized direction, and the second polarized direction may be a S-polarized direction. The P-polarized light passes through the first polarizer 324, and the light polarized in other directions are blocked by the first polarizer 324. The S-polarized light passes through the second polarizer 326, and the light polarized in other directions are blocked by the second polarizer 326. Moreover, in the present embodiment, the first polarizer 324 may be disposed between the light uniformized element 314 and the transmissive LCD panel 322, and the second polarizer 326 may be disposed between the transmissive LCD panel 322 and the projection lens 330. The material of the first polarizer 324 and the second polarizer 326 may include glass, quartz or sapphire. The light-transforming module 320 may include three first polarizers 324 capable of blocking the S-polarized light with different wavelengths.

To be specific, a P-polarized visible light passes through the first polarizers 324, and the visible light polarized in other directions are blocked by the first polarizers 324. In the present embodiment, the blocked visible light is the S-polarized visible light, and the wavelength of the S-polarized visible light is about 400 nm˜700 nm.

Moreover, in the present embodiment, the wavelength of the S-polarized light blocked by a first polarizer of the three first polarizers 324 (the first polarizer 324 located closest to the focusing lens 318) is about 400 nm˜500 nm. The wavelength of the S-polarized light blocked by a second polarizer of the three first polarizers 324 is about 500 nm˜600 nm. The wavelength of the S-polarized light blocked by a third polarizer of the three first polarizers 324 (the first polarizer 324 located closest to the transmissive LCD panel 322) is about 600 nm˜700 nm. Therefore, only the P-polarized light is left and transmitted to the transmissive LCD panel 322 after the light beam 310a passes through the first polarizers 324.

After the light beam 310a passes through the transmissive LCD panel 322, the P-polarized visible light therein is converted into the S-polarized visible light by the transmissive LCD panel 322 and transmitted to the second polarizer 326. Next, the S-polarized visible light passes through the second polarizer 326. Since the transmissive LCD panel 322 has the operation modes of being switched on and switched off, a part of the P-polarized visible light transmitted to the transmissive LCD panel 322 may directly pass through the transmissive LCD panel 322 without polarization conversion while the transmissive LCD panel 322 is switched off. In this case, the P-polarized visible light will be blocked by the second polarizer 326. Therefore, only the S-polarized light is left and transmitted to the projection lens 330 after the light beam 310a passes through the second polarizers 326.

It should be noted that since the light-transforming module 320 includes a plurality of the first polarizers 324, and the first polarizers 324 may respectively block the visible light with different wavelengths and being polarized in a direction other than the P-polarized direction, the light energy of the visible light polarized in other directions can be uniformly distributed on different first polarizers 324. Therefore, the heat accumulated on the first polarizers 324 may be more easily dissipated and the service life of the first polarizers 324 can be prolonged.

However, the present invention is not limited to the above embodiment as such. For example, light uniformized element 314 may be a combination of a concave lens and a lens array. Moreover, if the light beam 310a provided by the light source 310 is a parallel light beam, the light uniformized element 314 may be a lens array. In addition, the first polarizer 324 may be the S-polarizer, and the second polarizer 326 may be the P-polarizer. In this case, the first polarized direction is the S-polarized direction, and the second polarized direction is the P-polarized direction. Therefore, the S-polarized visible light passes through the first polarizer 324 and the P-polarized visible light is blocked by the first polarizer 324, and the P-polarized visible light passes through the second polarizer 326 and the S-polarized visible light is blocked by the second polarizer 326.

Moreover, allocation of the first polarizer 324 and the second polarizer 326 can be exchanged. In other words, the second polarizer 326 may be disposed between the light uniformized element 314 and the transmissive LCD panel 322, and the first polarizer 324 may be disposed between the transmissive LCD panel 322 and the projection lens 330. In this case, the light polarized in the second direction is capable of being converted into the light polarized in the first direction by the transmissive LCD panel 322. Furthermore, the light energy of the light polarized in the second direction can be uniformly distributed on different first polarizers 324 after the light passes through the transmissive LCD panel 322 while the transmissive LCD panel 322 is switched off.

Furthermore, the light polarized in the second direction may be blocked by the first polarizers 324 individually by means of transmittance attenuation or other method, such that only the light polarized in the first direction is left after the light beam 310a passes through the first polarizers 324. For example, a part of the light polarized in the second direction may be blocked first by the first polarizer of the first polarizers 324, and the remaining part of the light polarized in the second direction may pass through the first polarizer of the first polarizers 324. Next, another part of the light polarized in the second direction may be blocked by the second polarizer of the first polarizers 324, and the remaining part of the light polarized in the second direction may pass through the second polarizer of the first polarizers 324. Finally, all the light polarized in the second direction may be blocked by the third polarizer of the first polarizers 324, such that only the light polarized in the first direction is left after the light beam 310a passes through the first polarizers 324. In addition, to uniformly distribute the light energy of the light polarized in the second direction on the three first polarizers 324, the three polarizers 324 may respectively have a light transmittance of 66%, 50% and 0% for the second polarized direction.

Furthermore, the light-transforming module 320 is not only limited to include three first polarizers 324, but may include two or more first polarizers 324. Moreover, the light-transforming module 320 may also include a plurality of the second polarizers 326. The light polarized in the first direction other than the second polarized direction may be blocked by the second polarizers 326 by means of the aforementioned transmittance attenuation method or the method of individually blocking the light with different wavelengths.

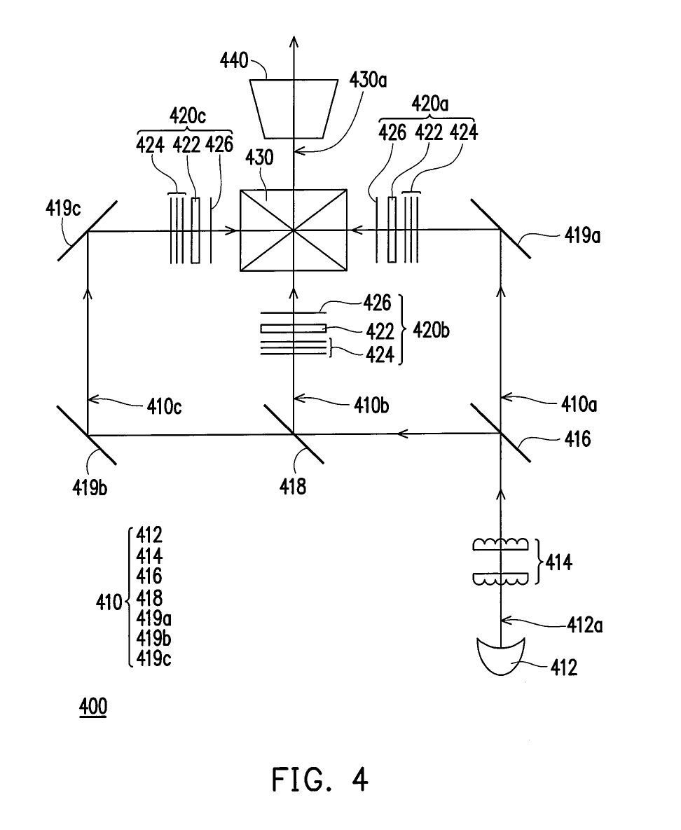

Referring to FIG. 4, the LCD projector 400 in a second embodiment of the present invention includes an illumination system 410, three light-transforming modules 420a, 420b and 420c, a beam combiner 430 and a projection lens 440. The illumination system 410 provides a light beam 412a including a first color light beam 410a, a second color light beam 410b and a third color light beam 410c. The light-transforming modules 420a, 420b and 420c are respectively disposed on transmission paths of the first color light beam 410a, the second color light beam 410b and the third color light beam 410c. Moreover, the beam combiner 430 is disposed on transmission paths of the first color light beam 410a, the second color light beam 410b and the third color light beam 410c, and is located behind the light-transforming modules 420a, 420b and 420c, by which the first color light beam 410a, the second color light beam 410b and the third color light beam 410c are combined to form a combination light beam 430a. The beam combiner 430 of this embodiment may be an X-prism.

In addition, the projection lens 440 may be disposed on a transmission path of the combination light beam 430a, and the combination light beam 430a is projected onto a screen (not shown) to form an image (not shown) via the projection lens 440. Moreover, each of the light-transforming modules 420a, 420b and 420c includes a transmissive LCD panel 422, a plurality of first polarizers 424 and at least a second polarizer 426. The first polarizer 424 is disposed at one side of the transmissive LCD panel 422, and the second polarizer 426 is disposed at another side of the transmissive LCD panel 422.

In this embodiment, the illumination system 410 may include a light source 412, a light uniformized element 414, a first beam splitter 416 and a second beam splitter 418. The first beam splitter 416 and the second beam splitter 418 may be dichroic mirrors. Composition of the light source 412 and the light uniformized element 414 is similar to that of the first embodiment, and therefore the description thereof will not be repeated. In addition, the light beam 412a may be a white light beam, and the first color light beam 410a, the second color light beam 410b and the third color light beam 410c may be a red light beam, a green light beam and a blue light beam, respectively.

Furthermore, the light uniformized element 414 and the first beam splitter 416 are sequentially disposed on the transmission path of the light beam 412a. When the light beam 412a is transmitted to the first beam splitter 416, the first color light beam 410a passes through the first beam splitter 416, and the second color light beam 410b and the third color light beam 410c are reflected by the first beam splitter 416. Moreover, the second beam splitter 418 is disposed on the transmission path of the second color light beam 410b and the third color light beam 410c. When the second color light beam 410b and the third color light beam 410c are transmitted to the second beam splitter 418, the third color light beam 410c passes through the second beam splitter 418 and the second color light beam 410b is reflected by the second beam splitter 418.

Furthermore, the illumination system 410 of the present embodiment further includes a plurality of reflective mirrors 419a, 419b and 419c. The reflective mirror 419a may be disposed on the transmission path of the first color light beam 410a, and the first color light beam 410a is reflected to the light-transforming module 420a by the reflective mirror 419a. The reflective mirrors 419b and 419c may be sequentially disposed on the transmission path of the third color light beam 410c, and the third color light beam 410c is reflected to the light-transforming module 420c by the reflective mirrors 419b and 419c. Moreover, the second color light beam 410b is suitable for being reflected to the light-transforming module 420b by the second beam splitter 418. Since the transmission paths of the first color light beam 410a, the second color light beam 410b and the third color light beam 410c respectively passing through the corresponding light-transforming modules 420a, 420b and 420c and being transmitted to the beam combiner 430 are approximately the same, the transmission path of the first color light beam 410a will be taken as an example in the following description.

In the present embodiment, the first polarizer 424 may be disposed between the light uniformized element 414 and the transmissive LCD panel 422. In specific, the first polarizer 424 is disposed between the reflective mirror 419a and the transmissive LCD panel 422. The second polarizer 426 may be disposed between the transmissive LCD panel 422 and the beam combiner 430. It should be noted that since the light-transforming module 420a includes the first polarizers 424, the light energy of the light polarized in the direction other than the first polarized direction may be is uniformly distributed on the first polarizers 424, such that the heat accumulated on the first polarizers may be more easily dissipated, and deterioration of the first polarizers due to high temperature is mitigated. Accordingly, the service life of the first polarizers may be prolonged.

In addition, the light polarized in the direction other than the first polarized direction in the first color light beam 410a may be blocked by the first polarizers 424 by means of individually blocking the light with different wavelengths and being polarized in the direction other than the first polarized direction, or by means of the aforementioned transmittance attenuation method or other methods, such that the light energy of the light polarized in the direction other than the first polarized direction may be uniformly distributed on the first polarizers 424. These methods are similar to that of the first embodiment, and therefore the detail description will not be repeated.

Furthermore, allocation of the first polarizers 424 and the second polarizer 426 can be exchanged. In other words, the second polarizer 426 may be disposed between the reflective mirror 419a and the transmissive LCD panel 422, and the first polarizer 424 may be disposed between the transmissive LCD panel 422 and the beam combiner 430. In this case, the light polarized in the second direction is suitable for being converted into the light polarized in the first direction by the transmissive LCD panel 422. Furthermore, the light energy of the light polarized in the second direction can be uniformly distributed on the first polarizers 424 after the light passes through the transmissive LCD panel 422 while the transmissive LCD panel 422 is switched off. Moreover, the light-transforming module 420a may also include a plurality of the second polarizers 426, such that the light energy of the light polarized in the first direction other than the second polarized direction can be uniformly distributed on the second polarizers 426. Furthermore, the material of the first polarizers 424 and the second polarizers 426 may be the same as that in the first embodiment.

In summary, since the light-transforming module of the present invention may include a plurality of the first polarizers (or a plurality of the second polarizers), the light energy of the light polarized in the direction other than the first (second) polarized direction may be uniformly distributed on the plurality of the first (second) polarizers. Therefore, the heat accumulated on the first (second) polarizers may be more easily dissipated, such that deterioration of the first (second) polarizers due to high temperature is mitigated, and the service life of the first (second) polarizers may be prolonged. Accordingly, a stable image quality of the transmissive LCD projector is maintained.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A liquid crystal projection apparatus, comprising:
an illumination system, for providing a light beam having light polarized in a first direction and light polarized in a second direction;
at least a light-transforming module, disposed on a transmission path of the light beam, the light-transforming module comprising:
a transmissive liquid crystal display panel;
a plurality of first polarizers, disposed at a side of the transmissive liquid crystal display panel, wherein the light polarized in the first direction passes through the first polarizers, a part of the light polarized in the second direction is blocked by one of the first polarizers, and a remaining part of the light polarized in the second direction is blocked by other first polarizers; and
at least a second polarizer, disposed at another side of the transmissive liquid crystal display panel, wherein the light polarized in the second direction passes through the second polarizer and the light polarized in the first direction is blocked by the second polarizer; and
a projection lens, disposed on the transmission path of the light beam, and located behind the light-transforming module.

2. The liquid crystal projection apparatus as claimed in claim 1, wherein the illumination system comprises:
a light source, for providing the light beam; and
a light uniformized element, disposed on the transmission path of the light beam.

3. The liquid crystal projection apparatus as claimed in claim 2, wherein the light uniformized element comprises a light integration rod and a lens array.

4. The liquid crystal projection apparatus as claimed in claim 3, wherein a length of the light integration rod is greater than 30 millimeters.

5. The liquid crystal projection apparatus as claimed in claim 1, wherein the second polarizer is disposed between the transmissive liquid crystal display panel and the projection lens.

6. The liquid crystal projection apparatus as claimed in claim 1, wherein the first polarizers are disposed between the transmissive liquid crystal display panel and the projection lens.

7. The liquid crystal projection apparatus as claimed in claim 1, wherein each of the first polarizers is capable of blocking the light polarized in the second direction with different wavelengths.

8. The liquid crystal projection apparatus as claimed in claim 1, wherein each of the first polarizers has a light transmittance for the light polarized in the second direction, and is capable of blocking a part of the light polarized in the second direction.

9. The liquid crystal projection apparatus as claimed in claim 1, wherein the light-transforming module includes a plurality of second polarizers, the light polarized in the second direction passes through the second polarizers, and the light polarized in the first direction is blocked by the second polarizers.

10. The liquid crystal projection apparatus as claimed in claim 9, wherein each of the second polarizers is capable of blocking the light polarized in the first direction with different wavelengths.

11. The liquid crystal projection apparatus as claimed in claim 9, wherein each of the second polarizers has a light transmittance for the light polarized in the first direction, and is capable of blocking a part of the light polarized in the first direction.

12. The liquid crystal projection apparatus as claimed in claim 1, comprising three light-transforming modules and further comprising a beam combiner, wherein the light beam comprises a first color light beam, a second color light beam and a third color light beam, the light-transforming modules are respectively disposed on a transmission path of the first color light beam, the second color light beam and the third color light beam, the beam combiner is disposed on the transmission path of the first color light beam, the second color light beam and the third color light beam, and is located behind the light-transforming modules, by which the first color light beam, the second color light beam and the third color light beam are combined to form a combination light beam.

13. The liquid crystal projection apparatus as claimed in claim 12, wherein each of the light-transforming modules, the second polarizer is disposed between the transmissive liquid crystal display panel and the beam combiner.

14. The liquid crystal projection apparatus as claimed in claim 12, wherein each of the light-transforming modules, the first polarizers are disposed between the transmissive liquid crystal display panel and the beam combiner.

15. The liquid crystal projection apparatus as claimed in claim 12, wherein the beam combiner comprises an X-prism.

16. The liquid crystal projection apparatus as claimed in claim 1, wherein the light polarized in the first direction is capable of being converted into the light polarized in the second direction by the transmissive liquid crystal display panel, or the light polarized in the second direction is capable of being converted into the light polarized in the first direction by the transmissive liquid crystal display panel.
